(19) United States
(12) Patent Application Publication
(10) Pub. No.: US 2024/0368721 A1
(43) Pub. Date: Nov. 7, 2024

(54) HOT-BATH FORMING PROCESS OF HIGH-CORROSION-RESISTANT AND EASY-TO-WELD HOT-PRESSED PART

(71) Applicant: SHANDONG IRON&STEEL GROUP RIZHAO CO., LTD., Shandong (CN)

(72) Inventors: Peixing LIU, Shandong (CN); Gang CHEN, Shandong (CN); Guangyu JIN, Shandong (CN); Liang HAO, Shandong (CN); Xingchang GAO, Shandong (CN); Peng GAO, Shandong (CN); Xiaoying HOU, Shandong (CN); Huasheng TANG, Shandong (CN); Weihua SUN, Shandong (CN)

(73) Assignee: SHANDONG IRON&STEEL GROUP RIZHAO CO., LTD., Shandong (CN)

(21) Appl. No.: 18/578,344

(22) PCT Filed: Jun. 9, 2022
(86) PCT No.: PCT/CN2022/097757

§ 371 Date: Jan. 11, 2024

(30) Foreign Application Priority Data
Sep. 14, 2021 (CN) 202111073382.7

(51) Int. Cl. C21D 9/46; B21D 22/02; C21D 1/673; C21D 8/02; C22C 38/00; C22C 38/02; C22C 38/04; C22C 38/06; C22C 38/22; C22C 38/26; C22C 38/28; C22C 38/32

(52) U.S. Cl. CPC C21D 9/46; B21D 22/022; C21D 1/673; C21D 8/0205; C21D 8/0247; C22C 38/001; C22C 38/002; C22C 38/02; C22C 38/04; C22C 38/06; C22C 38/22; C22C 38/26; C22C 38/28; C22C 38/32; C21D 2211/001

(57) ABSTRACT

The present invention relates to the field of sheet hot stamping and sheet metal parts manufacturing, and provides a hot bath forming process for high-corrosion-resistance easy-to-weld hot-pressed parts. The process comprises the following steps: S1, heating a coated hot-formed steel sheet material in a heating furnace, and heating to a completely austenitized state; S2, transferring the heated coated hot-formed steel sheet material into a boiling water tank, immersing the heated coated hot-formed steel sheet material into boiling water, and cleaning an oxide layer; S3, forming the coated hot-formed steel sheet material under the combined action of boiling water and an upper mold and a lower mold, and performing pressure maintaining and quenching to obtain parts; and S4, taking out the parts for air blowing or drying the parts in a drying furnace to remove water in the coating of the parts. According to the process provided in the present invention, the sheet material is immersed in boiling water, the surface oxide layer is uniformly and controllably removed by means of bubbles generated between the boiling water and the hot sheet material, and the forming temperature of the sheet material is uniformly and accurately controlled; moreover, forming and quenching are performed in boiling water, so that the production quality of the parts can be improved, the service life of the mold is prolonged, and the production cost is saved.

### CROSS REFERENCE TO RELATED APPLICATION

The present application claims priority to the Chinese Patent Application No. 202111073382.7, filed with the China National Intellectual Property Administration (CNIPA) on Sep. 14, 2021, and entitled “HOT BATH FORMING PROCESS FOR HIGH-CORROSION-RESISTANCE EASY-TO-WELD HOT-PRESSED PARTS”, which is incorporated herein by reference in its entirety.

### TECHNICAL FIELD

The present disclosure relates to the fields of sheet hot stamping and sheet metal part manufacturing, in particular to a hot-bath forming process of a high-corrosion-resistant and easy-to-weld hot-pressed part.

### BACKGROUND

The main processes in the hot stamping include blank heating, stamping and quenching, laser trimming, and shot blasting. Hot stamping is widely used due to small forming force, small springback of parts, and high strength of parts after forming. However, due to the lack of cathodic protection of hot-formed parts of bare plates and Al—Si plating plates, cutting edges of the parts may be corroded in advance during the service, especially the lower body parts, such as door sill beams.

The galvanized layer has a low melting point (a melting point of pure Zn is only about 400° C.), and the base material has a high austenitization temperature (850° C. to 900° C.). During the direct hot forming, the plating has preferably a lower temperature (not more than 650° C.), and the substrate has preferably a higher temperature (not less than 750° C.). For the traditional 22MnB5 substrate materials, a lower forming temperature (not less than 650° C.) may produce ferrite, resulting in insufficient strength. High forming temperature (such as 780° C.) for galvanized layer materials can cause the liquefied phase in the plating to invade the austenite grain boundary during the tensile stress deformation, thereby causing the matrix to crack, that is, the phenomenon of liquefied metal-induced embrittlement (LMIE). Therefore, for galvanized hot forming steel, the plating and the substrate are a contradiction. At present, there are mainly two approaches to solve the above problems, non-tensile stress deformation and lowering forming temperature.

The non-tensile stress deformation, such as the pre-forming process, mainly includes: cold stamping to form parts, heating and austenitizing the parts, stamping pressure maintaining and quenching, and shot blasting. In this process, the parts have been deformed in advance, and heated parts are transferred to the die and only quenched without tensile stress deformation. Therefore, there is no LMIE. However, in this process, the parts need to be cold-stamped in advance, and the parts are heated in the furnace, which shows high cost and complicated automation.

The lowering forming temperature, such as cooling in advance, mainly includes: cooling the heated sheet (using medium gas and dry ice), forming, and stamping pressure maintaining and quenching. However, this method shows difficult automatic control, and difficulty in cooling process and temperature control of the sheet metal. Moreover, it is difficult to evenly remove the oxide layer on the surface of parts.

Chinese patent CN106795578A disclosed a “Method for Intermediate Cooling of Steel Plates”. In this method, the surface is sprayed with “dry ice, dry snow, or airflow containing dry ice particles”, so as to realize the cleaning of the oxide layer on the surface of the galvanized steel sheet and the reduction of the temperature of the sheet. The cleaning power of the oxide layer on the surface of the steel plate comes from an impact force of external high-pressure “jet”. This method is difficult to achieve uniform cleaning of the surface oxide layer and uniform control of the sheet forming temperature; the method has the difficulty of automatic control; moreover, the method needs to prefabricate “dry ice, dry snow and other particles”, which have relatively high production costs.

Chinese patent CN101821429A disclosed a “Method and Device for Secondary Phosphorus Removal of Metal Strips by Low-Pressure Water Jetting”. In the method, during the rolling of the hot-rolled steel slab, a surface of the steel slab is sprayed with high-pressure water between the “rough rolling” and the “finish rolling” to remove the oxide layer on the surface of the steel slab. In this link, a thickness of the steel billet is generally 80 mm to 200 mm, which is relatively high, and a thickness of the oxide layer is generally 100 μm to 1 mm. The method is not suitable for the ultra-thin galvanized oxide layer of about 1 μm, and it is easy to clean the entire plating. Water at room temperature may reduce the sheet to room temperature (a cooling rate of a 1.5 mm thick hot steel plate in room-temperature water is 500° C./s to 1,000° C./s), making it difficult to control the temperature of the sheet.

Chinese patent CN107922988A disclosed a “Non-contact Cooling of Steel Plate Method and Device used in the Method”. In this method, air cooling is conducted with matrix tubes, which may easily cause uneven cooling temperature of the sheet metal. Moreover, the method has the difficulty in automatic control, and cannot clean the oxide layer on the surface of the material after heating.

Chinese patent CN107127238A disclosed a “Hot Stamping Forming Method of Zinc-based Plated Steel Sheet or Steel Strip”. In the method, a forming temperature of the plating sheet is lowered through a hot sheet trimming process. However, it is difficult to ensure uniform cooling of the material during the trimming, there is a low cooling rate at the trimming position, and high temperatures at other positions. The method shows great difficulty in automatic control.

Therefore, it is extremely important to develop a hot forming process with low cost, high corrosion resistance, easy welding, uniform and controllable removal of oxide layer, and uniform and controllable cooling temperature.

### SUMMARY

A purpose of the present disclosure is to overcome the deficiencies in the prior art, especially the difficulty in uniform and controllable cleaning of the extremely thin surface oxide layer and the difficulty in controlling the pre-cooling temperature. The present disclosure provides a hot-bath forming process of a high-corrosion-resistant and easy-to-weld hot-pressed part. This process balances a forming temperature of a plating with that of a substrate. A sheet plate is immersed in boiling water, an oxide layer on a surface of the steel plate is removed uniformly and controllably with the help of air bubbles generated between the boiling water and the hot sheet, and the forming temperature of the sheet can be uniformly and accurately controlled.

The present disclosure provides a hot-bath forming process of a high-corrosion-resistant and easy-to-weld hot-pressed part, including the following steps:
S1, heating coated hot forming steel in a heating furnace to a fully austenitized state; where
a plating of the coated hot forming steel is any one selected from the group consisting of a GI-type galvanized plating, a GA-type galvanized plating, and a Zn—Al—Mg alloy plating;
S2, transferring an obtained heated coated hot forming steel to a boiling water tank, immersing in boiling water, and cleaning a formed oxide layer;
S3, subjecting the coated hot forming steel to forming, stamping pressure maintaining, and quenching under the joint action of the boiling water, an upper die, and a lower die to obtain a part; and
S4, taking out the part to allow blowing or drying in a drying oven to remove moisture in the plating of the part.

Preferably, the heating furnace in step S1 has an atmosphere with an oxygen content (by volume percentage) of 5% to 20%. During the heating, the surface of the plating is oxidized, such that the aluminum element between the plating and the substrate diffuses to the surface of the plating and forms a dense layer of Al₂O₃, which suppresses the thickness of ZnO. However, an extremely low oxygen content may lead to the inability to form an oxide layer on the surface, causing most of the zinc to volatilize, such that a corrosion-resistant layer on the surface of the coated hot forming steel may be lost. If the oxygen content is extremely high and the ZnO layer is extremely thick, a welding performance can be affected.

The coated hot forming steel can be replaced with a laser tailor welded blank, a patch welded blank, or a variable-thickness rolled blank. Under the premise of ensuring that the substrate material is fully austenitized, the heating time should be shortened as much as possible. This prevents over-diffusion between the plating and the substrate, resulting in too low a corrosion-resistant element such as Zn in the plating, and reducing a cathodic protection effect. The heating is conducted to a target temperature of 850° C. to 900° C., and then heat preservation is conducted for 0.5 min to 4 min when the steel sheet reaches the target temperature.

Preferably, the boiling water in step S2 is at 80° C. to 100° C. and exerts a pressure of 0 bar to 0.1 bar on a surface of the oxide layer.

Preferably, the coated hot forming steel is immersed at a depth of 3 mm to 1,000 mm in the boiling water. When the sheet is immersed in boiling water, a steam insulation layer is be formed on its surface, and a transfer speed between the sheet temperature and the water can be greatly reduced, and a cooling rate of a 1.5 mm thick sheet in the vertical state is only 30° C./s to 50° C./s. When the depth is 3 mm to 1,000 mm, an internal pressure of the heat insulation layer is greater than a hydrostatic pressure of the steel plate in the water, thus forming air bubbles. The heat insulation layer is damaged, and the surface is cleaned during the formation of air bubbles to remove oxides such as ZnO, Al₂O₃, and MnO on the surface. “Insulation layer air bubbles” continue to form and continuously exert a cleaning effect on the surface of the steel plate. The sheet is immersed in the boiling water for 2 s to 20 s, the cooling rate in the boiling water is uniform and controllable, and it is easy to implement the cooling automatically. It is only necessary to control the time, posture, and position of the sheet in the boiling water.

Further, the boiling water further includes a dissolving agent with a mass fraction of 0% to 10%, and the dissolving agent includes NaOH in step S2. The parameters such as the time of the sheet in boiling water and the temperature of boiling water are determined according to the thickness of the oxide layer and the formability of the parts. A certain concentration of NaOH can be added to the boiling water as needed, and can accelerate dissolution of the oxide layer, and the NaOH should be washed off before the parts are dried.

Preferably, the forming in step S3 is conducted at 400° C. to 650° C. A lower die of the die is in a boiling water bath, and the tablet is placed above the lower die. When the press goes down, it drives an upper die down, and the coated hot forming steel is subjected to forming, stamping pressure maintaining, and quenching under the joint action of boiling water and the upper and lower dies. During the forming and pressure maintaining, the die destroys the heat insulation layer on the surface of the steel plate, the die is in direct contact with the sheet, and the rapid heat exchange between the sheet and the die realizes the quenching of the sheet.

Preferably, if the sheet is subjected to a heating stage and a boiling water bath cleaning stage, the surface state of the plating does not meet the subsequent welding and other processes, the method further includes: before the parts are taken out to allow blowing or drying in a drying oven, the part is removed from the boiling water tank and transferred to anaerobic room-temperature water to allow ultrasonic cleaning.

Further, the ultrasonic cleaning is conducted for 0.5 min to 5 min.

Preferably, the coated hot forming steel includes the following raw materials by mass percentage: 0.05 wt % to 0.35 wt % of C, 0.05 wt % to 0.2 wt % of Si, 0.5 wt % to 2.5 wt % of Mn, 0 wt % to 0.3 wt % of Cr, 0 wt % to 0.25 wt % of Mo, 0.02 wt % to 0.04 wt % of Ti, 0 wt % to 0.2 wt % of Nb, 0 wt % to 0.2 wt % of V, 0.002 wt % to 0.006 wt % of B, 0 wt % to 0.020 wt % of P, 0 wt % to 0.003 wt % of S, 0.02 wt % to 0.06 wt % of Al, 0 wt % to 0.006 wt % of N, and Fe as a balance.

Preferably, the plating has a thickness of 5 μm to 30 μm.

The technical solution of the present disclosure has the following advantages:

1. In the present disclosure, the process can uniformly control the oxide layer removal and the sheet temperature cooling at the same time. The automatic control of the entire control process is easy to implement, and only needs to control a boiling water flow pressure (flow velocity) in the water tank, as well as the position, posture, and time of the steel plate in the water.

2. In the process of the present disclosure, the power to remove the oxide layer on the surface of the steel plate comes from the heat release between the steel plate and the boiling water, and an impact force generated by the vaporization and rupture of the boiling water on the surface of the steel plate to form air bubbles. The surrounding water moves quickly and rapidly takes away the oxides. The cleaning power is weak, and is highly suitable for the surface oxide layer of about 1 μm. If the surface pressure is too high, the plating may be removed as a whole, and the oxide layer may be removed unevenly. The present disclosure can realize “long time” and “low cleaning power air bubble method” to remove the oxide layer.

3. In the present disclosure, the process is convenient for actual production, and it is only necessary to place the die in boiling water and delay a die closing time. In addition, during the mass production, the temperature of the sheet metal can be continuously transferred to the water, and the energy consumption of the boiling water bath can be greatly reduced during the continuous production. The die is placed in boiling water, and the lower die does not need to be equipped with cooling channels, thus greatly reducing the processing and manufacturing costs of the die. Moreover, a die temperature is constant, which reduces the thermal fatigue of the die and reduces the damage of the die. In addition, the plating has solidified and no longer sticks to the die during forming, and the heat absorbed by the die is reduced, which is beneficial to improve the service life of the die. This can realize the functions of cleaning and cooling before sheet forming. In the stamping pressure maintaining, the quenching and cooling rates of the sheet metal can be reduced, and the microstructure and properties of the sheet metal can be improved. This can also effectively relieve the cracking when the surface oxide layer of the low-melting-point and corrosion-resistant coating is formed.

4. In this process, the die will not rust in boiling water. Since an oxygen content in boiling water is 0, the Fe element in the die material cannot be in contact with oxygen, thus not causing die corrosion.

5. In this process, the stamping is completed in a boiling water bath, which isolates the contact between the sheet and oxygen, thereby avoiding the oxidation of the sheet during transferring and forming.

### BRIEF DESCRIPTION OF THE DRAWINGS

To describe the technical solutions in the specific implementations of the present disclosure or the prior art more clearly, the accompanying drawings required for describing the specific implementations or the prior art are briefly described below. Apparently, the accompanying drawings in the following description show merely some implementations of the present disclosure, and a person of ordinary skill in the art may still derive other accompanying drawings from these accompanying drawings without creative efforts.

FIG. 1 shows a schematic flow chart of the hot-bath forming process of a high-corrosion-resistant and easy-to-weld hot-pressed part provided by the present disclosure;

FIG. 2 shows a cooling process of a steel sheet in boiling water in Example 1 of the present disclosure; where A and B are actual cooling curves of a two-point steel sheet at center and edge of the steel sheet, respectively, and the cooling is high uniform;

FIG. 3 shows a surface appearance of the plating of the part treated in boiling water bath in Example 1 of the present disclosure;

FIG. 4 shows an appearance of the plating at an outer side of a corner of the part treated in boiling water bath in Example 1 of the present disclosure;

FIG. 5 shows a surface appearance of a plating of a traditional air-cooled part in Comparative Example 1; and

FIG. 6 shows a cracking appearance of a plating at an outer side of a corner of a direct hot-stamped part in Comparative Example 2.

### DETAILED DESCRIPTION OF THE EMBODIMENTS

### Example 1

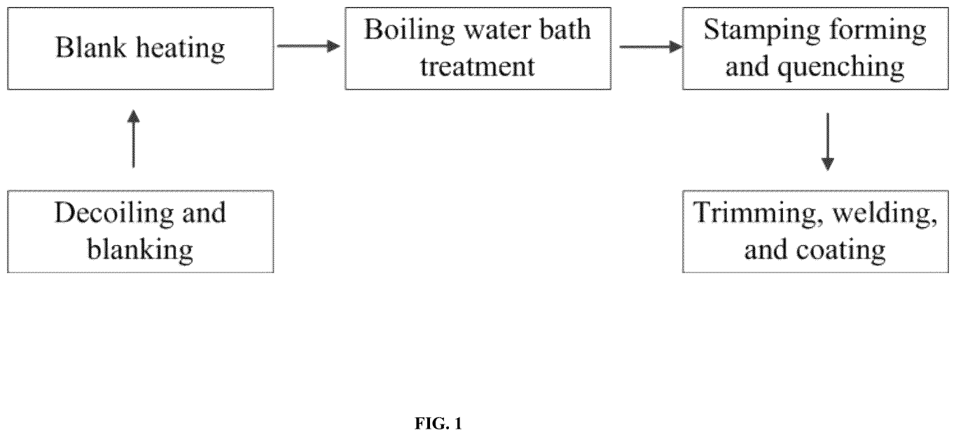

As shown in FIG. 1, a hot-bath forming process of a high-corrosion-resistant and easy-to-weld hot-pressed part included the following steps:

S1. A 1.5 mm thick galvanized hot forming steel sheet (a substrate included the following components: C 0.18-0.21 wt %, Si 0.05-0.2 wt %, Mn 1.5-2.2 wt %, Cr 0-0.3 wt %, Mo 0-0.25 wt %, Ti 0.02-0.04 wt %, Nb 0-0.1 wt %, B 0.002-0.006 wt %, P 0-0.020 wt %, S 0-0.003 wt %, Al 0.02-0.06 wt %, and N 0-0.006 wt %; a double GI-type galvanized plating was 150 g/m², and a single side thickness was 11 μm) was transferred to a box-type heating furnace at 890° C. to allow heat preservation for 5 min to complete austenitization; where the heating furnace had an atmosphere with an oxygen content (by volume fraction) of 20%.

S2. An obtained heated steel sheet was transferred to a boiling water tank, immersed in boiling water at a depth of 3 mm to 1,000 mm and 100° C. to allow even cleaning for 6 s, and then cooled.

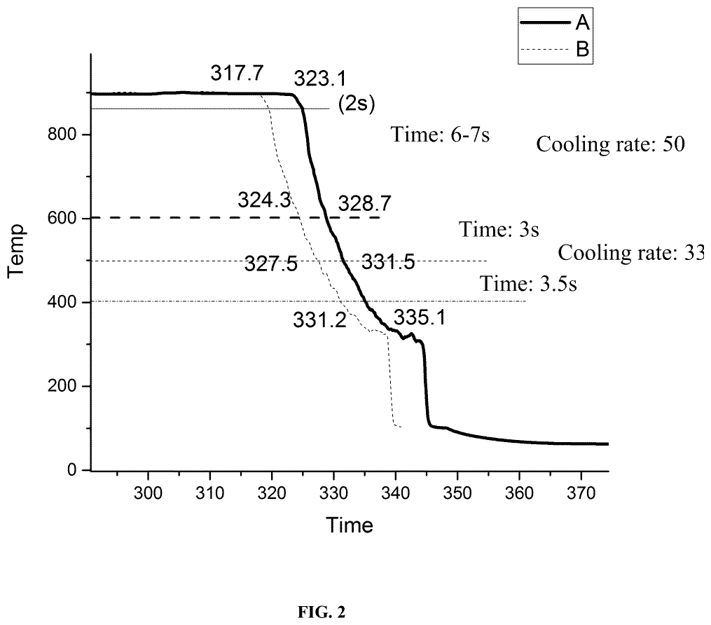

S3. Since a die was in the boiling water bath, only a die closing time delay of a hydraulic press was controlled at 6 s, and the die closing (the die closing required 3 s) was conducted to allow forming, quenching, and pressure maintaining in sequence. The steel sheet was immersed in the boiling water for about 9 s in total before forming, such that a temperature of the steel sheet before forming was 520° C. to 560° C. (FIG. 2). The stamping pressure maintaining with a quench duration of 10 s; the die closing holding force was 100 T (the part showed a projected area pressure of 20 MPa).

S4. The part taken out from water was blown to allow drying to remove surface moisture of the part, thus obtaining a finished product.

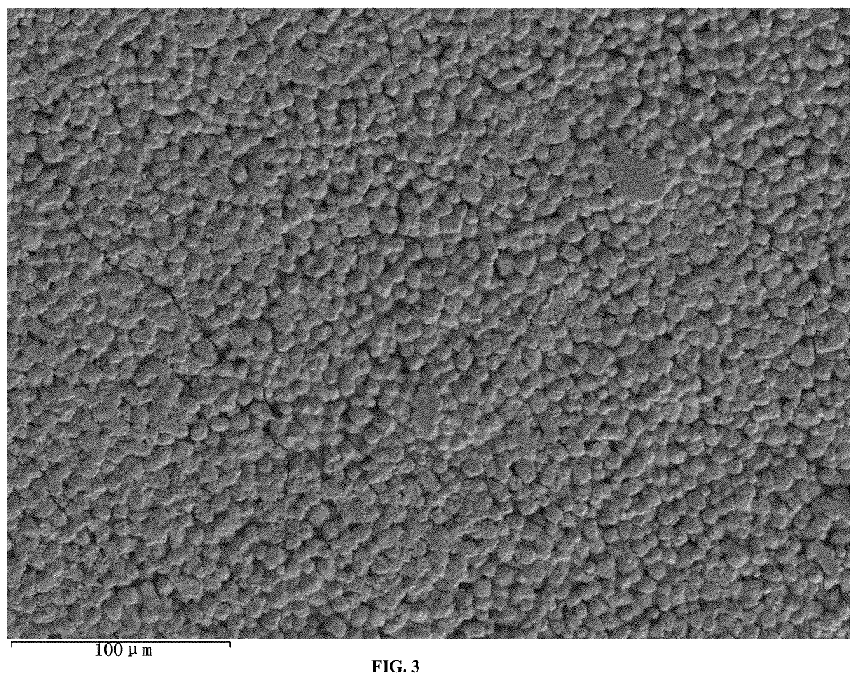

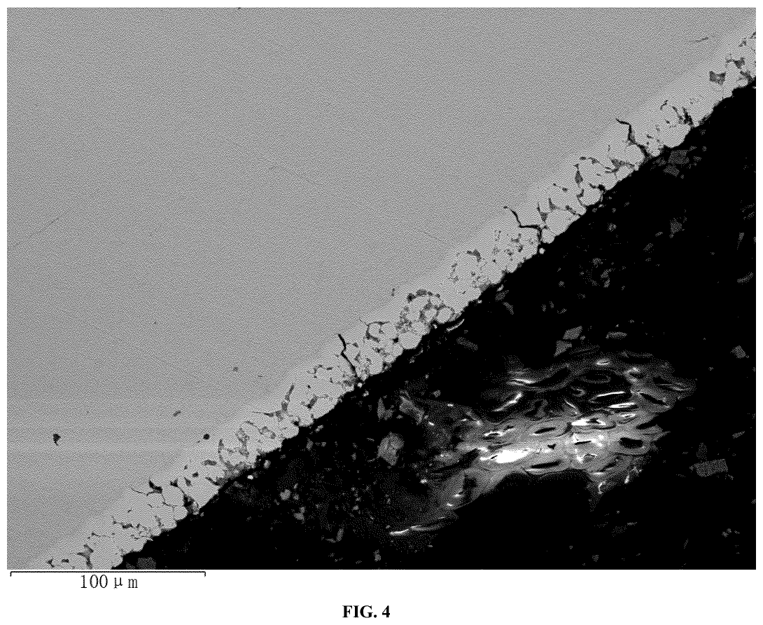

The mechanical properties of the part after forming (test standard: GB/T 228.1-2010 “Metallic materials—Tensile testing—Part 1: Method of test at room temperature”) were as follows: tensile strength was 1,420 MPa to 1,600 MPa, elongation after fracture was 5% to 9%. The surface appearance of the parts was shown in FIG. 3, the surface treated by the boiling water bath was granular and highly uniform, and there was almost no large-scale continuous oxide layer. A current window of the welding process of a final part was 1.1 kA to 1.4 kA, which fully met the requirements of the current welding process. Moreover, the plating had no liquefaction cracking (FIG. 4); the galvanized layer after forming and quenching had a Zn content of 32% to 55%, and showed a desirable cathodic protection effect.

### Example 2

A hot-bath forming process of a high-corrosion-resistant and easy-to-weld hot-pressed part included the following steps:

S1. A 1.5 mm thick galvanized hot forming steel sheet (a substrate included the following components: C 0.05-0.35 wt %, Si 0.05-0.2 wt %, Mn 0.5-2.5 wt %, Cr 0-0.3 wt %, Mo 0-0.25 wt %, Ti 0.02-0.04 wt %, Nb 0-0.2 wt %, V 0-0.2 wt %, B 0.002-0.006 wt %, P 0-0.020 wt %, S 0-0.003 wt %, Al 0.02-0.06 wt %, N 0-0.006 wt %, and Fe as a balance; a double GA-type galvanized plating was 150 g/m², and a single side thickness was 11 μm) was transferred to a box-type heating furnace at 900° C. to allow heat preservation for 5 min to complete austenitization; where the heating furnace had an atmosphere with an oxygen content (by volume fraction) of 20%.

S2. An obtained heated steel sheet was transferred to a boiling water tank, immersed in boiling water at a depth of 3 mm to 1,000 mm and 80° C. to allow even cleaning for 6 s, and then cooled.

S3. Since a die was in the boiling water bath, only a die closing time delay of a hydraulic press was controlled at 6 s, and the die closed to form, stamping pressure maintain and quench. The steel sheet was immersed in the boiling water for about 9 s in total before forming, such that a temperature of the steel sheet before forming was 500° C. to 600° C. The stamping pressure maintaining was conducted for 10 s; the die closing force was 100 T.

S4. The part taken out of the water was transferred to anaerobic room-temperature water to allow ultrasonic cleaning, such that an oxide layer on the surface of the part was cleaned by ultrasonic vibration for 0.5 min to 5 min. The part taken out from water was blown to allow drying to remove surface moisture of the part, thus obtaining a finished product.

The mechanical properties, weldability, and plating liquefaction cracking effect of the part after forming were the same as those in Example 1.

### Comparative Example 1

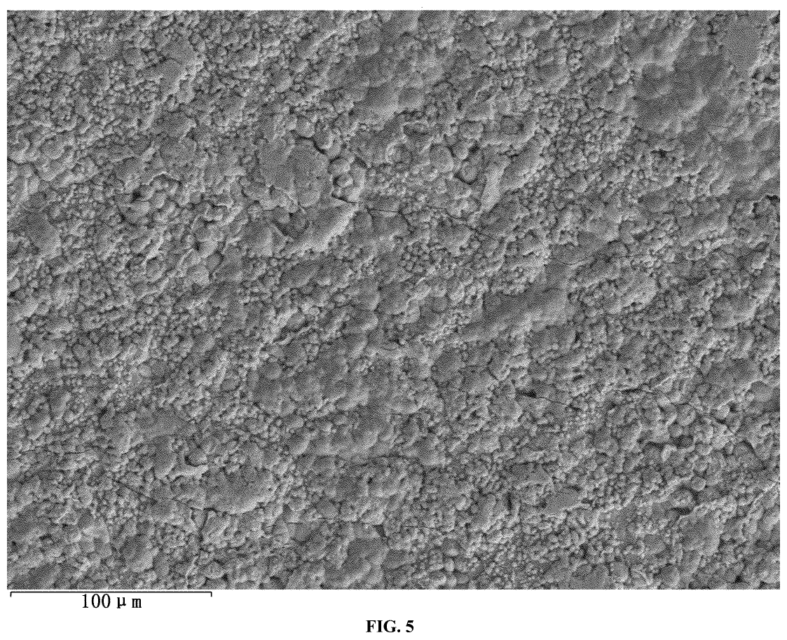

A part was produced by traditional air-cooling (CN107922988A for process details). A surface appearance of the part was shown in FIG. 5, indicating unevenness and large-scale contiguous oxide layers.

### Comparative Example 2

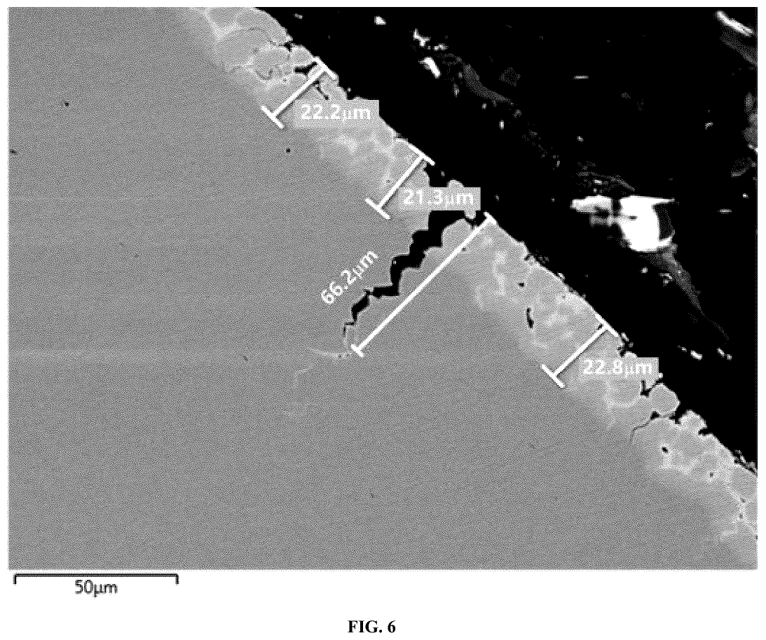

A part was prepared by direct hot forming, referring to “YI Hongliang, CHANG Zhiyuan, CAI Helong, et al. Strength, plasticity, and fracture strain of hot-stamped steel [J]. Acta Metallica Sinica, 2020, v.56(04):51-65.”. A specific process included: a part slab was heated to about 930° C. in a heating furnace to form a uniform full austenite structure; the austenite structure was transferred to a press by a manipulator, a die was closed and then stamped at 700° C. to 800° C., to form a fully austenitic state with a tensile strength of about 200 MPa and an elongation of more than 40%. A cooling water system in the die maintained a surface temperature of the die at 50° C. to 100° C., and formed a full martensitic structure through heat conduction and quenching of the die while stamping and forming were conducted. After the part was assembled, the body-in-white of the part was painted and baked at 150° C. to 180° C. for 10 min to 20 min. For the plating obtained by this process, the liquefied zinc invaded the substrate by more than 40 μm, as shown in FIG. 6. As a result, this plating could not satisfy service performance, especially fatigue resistance.

It is apparent that the above embodiments are merely listed for clear description, and are not intended to limit the implementations. The person of ordinary skill in the art may make modifications or variations in other forms based on the above description. There are no need and no way to exhaust all the implementations. Obvious changes or variations made thereto shall still fall within the protection scope of the present disclosure.

1. A hot-bath forming process of a high-corrosion-resistant and easy-to-weld hot-pressed part, comprising the following steps:
S1: heating a plating-containing hot forming steel sheet in a heating furnace to a fully austenitized state; wherein
a plating of the plating-containing hot forming steel sheet is any one selected from the group consisting of a GI-type galvanized plating, a GA-type galvanized plating, and a Zn—Al—Mg alloy plating;
S2: transferring an obtained heated plating-containing hot forming steel sheet to a boiling water tank, immersing in boiling water, and cleaning a formed oxide layer;
S3: subjecting the plating-containing hot forming steel sheet to forming, pressure maintaining, and quenching under a joint action of the boiling water, an upper mold, and a lower mold to obtain a part; and
S4: taking out the part to allow blowing or drying in a drying oven to remove moisture in the plating of the part.

2. The hot-bath forming process of a high-corrosion-resistant and easy-to-weld hot-pressed part according to claim 1, wherein the heating furnace in step S1 has an atmosphere with an oxygen content of 5% to 20%.

3. The hot-bath forming process of a high-corrosion-resistant and easy-to-weld hot-pressed part according to claim 1, wherein the heating is conducted to a target temperature of 850° C. to 900° C., and then heat preservation is conducted for 0.5 min to 4 min when the steel sheet reaches the target temperature in step S1.

4. The hot-bath forming process of a high-corrosion-resistant and easy-to-weld hot-pressed part according to claim 1, wherein the boiling water in step S2 is at 80° C. to 100° C. and exerts a pressure of 0 bar to 0.1 bar on a surface of the oxide layer.

5. The hot-bath forming process of a high-corrosion-resistant and easy-to-weld hot-pressed part according to claim 4, wherein the plating-containing hot forming steel sheet is immersed at a depth of 3 mm to 1,000 mm in the boiling water.

6. The hot-bath forming process of a high-corrosion-resistant and easy-to-weld hot-pressed part according to claim 1, wherein the boiling water exerts a pressure of 0 bar to 0.1 bar on a surface of the oxide layer of the hot forming steel sheet.

7. The hot-bath forming process of a high-corrosion-resistant and easy-to-weld hot-pressed part according to claim 1, wherein the hot forming steel sheet is immersed in the boiling water for 2 s to 20 s.

8. The hot-bath forming process of a high-corrosion-resistant and easy-to-weld hot-pressed part according to claim 4, wherein the boiling water further comprises a dissolving agent with a mass fraction of 0% to 10%, and the dissolving agent comprises NaOH.

9. The hot-bath forming process of a high-corrosion-resistant and easy-to-weld hot-pressed part according to claim 1, wherein the forming in step S3 is conducted at 400° C. to 650° C.

10. The hot-bath forming process of a high-corrosion-resistant and easy-to-weld hot-pressed part according to claim 1, wherein the lower mold is in the boiling water, and the plating-containing hot forming steel sheet is placed above the lower mold in step S3.

11. The hot-bath forming process of a high-corrosion-resistant and easy-to-weld hot-pressed part according to claim 1, further comprising: before the part is taken out to allow the blowing or the drying in a drying oven, transferring the part from the boiling water tank to anaerobic room-temperature water to allow ultrasonic cleaning.

12. The hot-bath forming process of a high-corrosion-resistant and easy-to-weld hot-pressed part according to claim 11, wherein the ultrasonic cleaning is conducted for 0.5 min to 5 min.

13. The hot-bath forming process of a high-corrosion-resistant and easy-to-weld hot-pressed part according to claim 1, wherein the hot forming steel sheet comprises the following raw materials by mass percentage: 0.05 wt % to 0.35 wt % of C, 0.05 wt % to 0.2 wt % of Si, 0.5 wt % to 2.5 wt % of Mn, 0 wt % to 0.3 wt % of Cr, 0 wt % to 0.25 wt % of Mo, 0.02 wt % to 0.04 wt % of Ti, 0 wt % to 0.2 wt % of Nb, 0 wt % to 0.2 wt % of V, 0.002 wt % to 0.006 wt % of B, 0 wt % to 0.020 wt % of P, 0 wt % to 0.003 wt % of S, 0.02 wt % to 0.06 wt % of Al, 0 wt % to 0.006 wt % of N, and Fe as a balance.

14. The hot-bath forming process of a high-corrosion-resistant and easy-to-weld hot-pressed part according to claim 1, wherein the plating has a thickness of 5 μm to 30 μm.

15. The hot-bath forming process of a high-corrosion-resistant and easy-to-weld hot-pressed part according to claim 1, wherein the hot forming steel sheet is replaced with a laser tailor welded blank, a patch welded blank, or a variable-thickness rolled blank.

16. The hot-bath forming process of a high-corrosion-resistant and easy-to-weld hot-pressed part according to claim 4, wherein the boiling water exerts a pressure of 0 bar to 0.1 bar on a surface of the oxide layer of the hot forming steel sheet.

17. The hot-bath forming process of a high-corrosion-resistant and easy-to-weld hot-pressed part according to claim 5, wherein the boiling water exerts a pressure of 0 bar to 0.1 bar on a surface of the oxide layer of the hot forming steel sheet.

18. The hot-bath forming process of a high-corrosion-resistant and easy-to-weld hot-pressed part according to claim 4, wherein the hot forming steel sheet is immersed in the boiling water for 2 s to 20 s.

19. The hot-bath forming process of a high-corrosion-resistant and easy-to-weld hot-pressed part according to claim 5, wherein the hot forming steel sheet is immersed in the boiling water for 2 s to 20 s.
